(19) United States
(12) Patent Application Publication
(10) Pub. No.: US 2024/0303650 A1
(43) Pub. Date: Sep. 12, 2024

(54) SYSTEMS AND METHODS FOR MULTI-STAGE RESIDUAL MODELING APPROACH FOR ANALYSIS AND ASSESSMENT

(71) Applicant: MASTERCARD INTERNATIONAL INCORPORATED, Purchase, NY (US)

(72) Inventors: Chengxi Li, Riverside, CT (US); Christopher John Merz, Wildwood, MO (US); Felix Johannes Flory, Wildwood, MO (US)

(21) Appl. No.: 18/179,094

(22) Filed: Mar. 6, 2023

(51) Int. Cl. G06Q 20/40; G06F 30/20

(52) U.S. Cl. CPC G06Q 20/401; G06F 30/20; G06Q 20/407

(57) ABSTRACT

A computer system for multi-stage residual modeling for authorizing an online user is provided. The computer system is programmed to store a plurality of models for analyzing transactions including a first model and a second model; receive a plurality of authorization data associated with a user and a transaction associated with the user; execute in real-time the first model using the plurality of authorization data to receive a first output for the first model, wherein the first output is within an output range; determine a remainder from the first model based on the first output and the output range; execute the second model using the plurality of authorization data and the remainder to generate a second output; combine the first output and the second output to generate a final output; and return the final output for decisioning on whether to authorize the transaction.

### BACKGROUND

The present application relates generally to using a multi-stage residual modeling approach for analyzing and authorizing data, and more particularly, to network based systems and methods that use a real-time mathematical residual modeling approach for analyzing messages for authorization purposes sent over an electronic network.

Many different strategies are used to analyze computer messages sent over computer networks. Recent data privacy and regulations make message analysis more challenging than ever. Traditionally, ensemble models, like second-stage models, are built to consolidate multiple signals for analyses. However, there may be competition and conflicts when integrating various signals together. In addition, the integration process is complex, which includes the difficulties of synchronizing multiple assets/services that are in production. Also different products or signals may have different footprints or coverage, which can lead to bias and confusion in the discriminate model in the final stage.

In one example, transaction card network companies continue to try and increase the effectiveness and sophistication of transaction behavior profiles. However, recent data privacy regulations make transaction validity assessment more challenging than ever. Annually, card issuers suffer substantial financial losses due to card fraud, and, consequently, large sums of money can be saved if successful and effective fraud detection techniques are applied. For example, one model used for detecting fraud may have broader coverage than another model because of on-soil requirements, data quality, customer population, etc. This makes it challenging for the arbitrator to make a fraud judgment because of an incomplete picture of the transaction. Furthermore, the integration process of integrating multiple models together is complex considering the difficulties of synchronizing multiple assessments in production and the complicated hierarchy for stacking multiple validity scores.

Computer systems are able to provide access to large amounts of data. In some cases, this data may be highly confidential data such that access to this data is restricted to those users requiring access and/or those users that are authorized to access such data. For example, healthcare data of a patient or financial data of a consumer may be highly confidential data that only the patient or consumer can access and only those other persons that the patient or consumer approves to access such data. When access to such data is restricted, the computer system must employ authentication and authorization services to ensure that the persons accessing such data are legitimately authorized to access such data. In other words, if only the patient is authorized to access their data, then the computer system storing such data must be able to confirm that the patient is the person logging in to access their own data.

Another example of accessing restricted data includes the financial industry. Financial transactions conducted over electronic payment networks are growing exponentially. In some cases, these transactions are performed by parties over computer networks using payment cards and/or payment accounts wherein the payment cards or other forms of identification are not presented to the merchant at the time of the transaction. For these card-not-present transactions (e.g., transactions in which the consumer does not actually provide a payment card to the merchant), fraud is markedly present in some of those transactions with the merchant. Accordingly, for such transactions, authorization and/or authentication procedures are often implemented to verify that the alleged cardholder is, in fact, the actual or legitimate cardholder.

An effective payment fraud detection system would provide merchants and issuers with accurate and efficient compromised detection assessments based on authentication, authorization, and customer behaviors.

Accordingly, it would be desirable to use a methodology of multi-stage residue modeling to integrate multiple signals for making a message validity assessment of a transaction. This can be used to accommodate message validity detection scenarios for integrating various signals, encourage collaboration, and enhance model performance.

### BRIEF DESCRIPTION

In one aspect, a computer system for multi-stage residual modeling for authorizing an online user is provided. The computer system includes at least one memory device and at least one processor coupled to the at least one memory device. The at least one processor is programmed to store a plurality of models for analyzing transactions including a first model and a second model. The at least one processor is also programmed to receive a plurality of authorization data associated with a user and a transaction associated with the user. The at least one processor is further programmed to execute in real-time the first model using the plurality of authorization data to receive a first output for the first model. The first output is within an output range. In addition, the at least one processor is programmed to determine a remainder for the first model based on the first output and the output range. Moreover, the at least one processor is programmed to execute the second model using the plurality of authorization data and the remainder to generate a second output. Furthermore, the at least one processor is programmed to combine the first output and the second output to generate a final output. In addition, the at least one processor is also programmed to return the final output for decisioning on whether to authorize the transaction.

In another aspect, a computer-implemented method for multi-stage residual modeling for authorizing an online user is provided. The method is implemented on a computing device comprising at least one memory device coupled to at least one processor. The method includes storing a plurality of models for analyzing transactions including a first model and a second model. The method also includes receiving a plurality of authorization data associated with a user and a transaction associated with the user. The method further includes executing in real-time the first model using the plurality of authorization data to receive a first output for the first model. The first output is within an output range. In addition, the method includes determining a remainder for the first model based on the first output and the output range. Moreover, the method includes executing the second model using the plurality of authorization data and the remainder to generate a second output. Furthermore, the method includes combining the first output and the second output to generate a final output. In addition, the method also includes returning the final output for decisioning on whether to authorize the transaction.

In another aspect, at least one non-transitory computer-readable storage medium having computer-executable instructions embodied thereon for multi-stage residual modeling for authorizing an online user is provided. When executed by at least one processor, the computer-executable instructions cause the at least one processor to store a plurality of models for analyzing transactions including a first model and a second model. The computer-executable instructions also cause the at least one processor to receive a plurality of authorization data associated with a user and a transaction associated with the user. The computer-executable instructions further cause the at least one processor to execute the first model using the plurality of authorization data to receive a first output for the first model. The first output is within an output range. In addition, the computer-executable instructions cause the at least one processor to determine a remainder for the first model based on the first output and the output range. Moreover, the computer-executable instructions cause the at least one processor to execute the second model using the plurality of authorization data and the remainder to generate a second output. Furthermore, the computer-executable instructions cause the at least one processor to combine the first output and the second output to generate a final output. In addition, the computer-executable instructions cause the at least one processor to return the final output for decisioning on whether to authorize the transaction.

### BRIEF DESCRIPTION OF THE DRAWINGS

FIGS. 1-10 show example embodiments of the methods and systems described herein.

FIG. 1 is a schematic diagram illustrating an example multi-stage residual modeling (MSRM) platform in communication with a multi-party payment processing system for processing transactions in accordance with one embodiment of the present disclosure.

FIG. 2 is an expanded block diagram of an example embodiment of a computer network for analyzing computer network message traffic in the processing system shown in FIG. 1.

FIG. 3 illustrates an example configuration of a server system such as the server system shown in FIG. 2.

FIG. 4 illustrates an example configuration of a client system shown in FIG. 2.

FIG. 5 is a flow diagram of an example method for authorizing an online user using the MSRM network shown in FIG. 2.

FIG. 6 is an example schematic diagram illustrating transaction flow in using the MSRM system shown in FIG. 2.

FIG. 7 is an example schematic diagram illustrating the mathematics in using the transaction flow shown in FIG. 6.

FIG. 8 is another example schematic diagram illustrating transaction flow in using the MSRM system shown in FIG. 2.

FIG. 9 is another example schematic diagram illustrating mathematics in using the transaction flow shown in FIG. 8.

FIG. 10 is a flow diagram of an example method for modeling authorization for an online user on behalf of a MSRM network shown in FIG. 2.

Although specific features of various embodiments may be shown in some drawings and not in others, this is for convenience only. Any feature of any drawing may be referenced and/or claimed in combination with any feature of any other drawing.

### DETAILED DESCRIPTION

The present application relates generally to analyzing data included within authentication and/or authorization messages sent over an electronic network, and more particularly, to a network-based system and method for using a multi-stage residual modeling approach to analyze such computer messages. In at least one embodiment, the system may be used for authenticating and/or authorizing a user attempting to access data or access online services. A multi-stage residual modeling (MSRM) computer device is used to analyze the data included in an authorization or authentication request message by applying multiple models in a multi-stage residual modeling approach. The MSRM computer device or server receives an authorization request message and/or authentication request message and analyzes in real-time the data included in the request messages to determine a correlation between data included in the messages and fraud indicators that are included in the fraud modeling process. Specifically, the MSRM server applies a first classification model, and then applies one or more second stage models to the residual data (e.g., data gaps not captured by the first model) to determine a final scoring output by adding the output from the first model with the output from the second model. Then the MSRM server generates an authentication or authorization decision (e.g., approves or declines the transaction) based on the final scoring output, or provides the score along with a recommendation to a third-party (e.g., issuer or other party) by updating the authentication or authorization request message with the score data and sending the updated message to the third-party.

In the example embodiment, the MSRM server calculates a fraud score (e.g., indicating a likelihood of a fraudster attempting to access data or initiate a payment transaction or otherwise receive value-added services instead of the legitimate owner receiving those services) for a transaction message associated with a cardholder using the multi-stage residual modeling approach. Once the fraud score is calculated using the multi-party residual modeling approach, the fraud score is inserted within a data field included within an authorization message that is then provided to an issuer or third-party computing device for making a decision on whether to complete the transaction. The fraud score may also include an indication of the type of classification models used in the modeling process. The authorization request message includes final fraud score from the fraud analysis. Accordingly, the message is sent through the payment network to the issuing bank for further review and response.

In another example, a bank that issued a payment card for a transaction (referred to as the issuer) contracts with a third-party associated with the issuer computer device for authorization services. In at least some embodiments, the issuer computer device is associated with the MSRM server or in some cases the MSRM server is associated with the payment processing network, and performs the modeling services and authorization process on behalf of the issuer. In still further embodiments, the issuer computer device is a part of the MSRM server. Specifically, the issuer computer device analyzes at least some of the data associated with the transaction, determines whether or not it is likely that the alleged cardholder is, in fact, the actual or legitimate cardholder, and reports that determination to the actual issuer.

In some markets, regulators may mandate strong consumer authentication or authorization on certain types of transactions, such as card-not-present (CNP) transactions. Such regulation is directed at reducing online fraud, but often at the expense of customer and merchant satisfaction. For example, forcing customers to provide password or pin information or respond to a text message for 100% of transactions within that market increases friction in online purchasing environments, leading to increased rates of abandonment due to the customers' frustrations. However, in at least some known authorization systems, fraud models are stacked or combined together, by applying them individually, and generating separate fraud scores which are then combined using an additional weighting model (e.g., an arbitrator function) that must be separately determined. Accordingly, a determination is made as to which model will be given more weight, and how much weight will be given. This is a very time consuming approach and requires significant computation resources to perform these calculations. Moreover, these calculations need to be updated continuously as new transactions are scored.

In a further embodiment of the systems and methods described herein, to prevent fraudulent transactions, the system may be implemented to determine whether a payment transaction or other transaction is authorized by the legitimate cardholder and not a fraudster. To address the limitations set forth above of these known authorization systems, in the systems and methods described herein, fraud models may be stacked together using the multi-stage residual model approach that enhances a residual piece of information that may not have been obtained by using a first model. Specifically, the residual piece of data, also known as data gaps from the first model, is a focus of the second model. These multiple models are used to make recommendations to a card issuer by adopting insights gained from the multi-stage modeling. The modeling process happens in real-time while a transaction is being processed. As explained below, this multi-stage residual approach generates improved fraud detection results, with faster processing times and less computation resources being used.

In example embodiments of the systems and methods described herein, a multi-stage residue modeling approach is used, which keeps one fraud classification model (e.g., model 1) as a key driver model, and uses the residual output from model 1 for further validity assessments by using the residual output of the first model as the target of the second-stage model, a regression model for validity adjustment. Residuals are any validity assessment not successfully predicted by the earlier applied models and added to the next model's target, and then compared to the ground truth of actual fraud.

In another example, a bank that issued a payment card for a transaction (referred to as the issuer) contracts with an access control server (ACS) for authentication services. In at least some embodiments, the ACS is associated with the MSRM server. In still further embodiments, the ACS is a part of the MSRM server. Specifically, the ACS analyzes at least some of the data associated with the transaction, determines whether or not it is likely that the alleged cardholder is, in fact, the actual or legitimate cardholder, and reports that determination to the issuer.

In a further embodiment, the MSRM server receives a plurality of previously processed authentication request messages for transactions. The plurality of previously processed authentication request messages also include whether or not the corresponding authentication request was fraudulent. In other embodiments, the MSRM server receives a plurality of information from a plurality of previously processes authentication request messages for transactions. In some of these embodiments, the plurality of information includes fraud processing calculations performed by one or more servers in the transaction authentication system.

Then the MSRM server uses artificial intelligence (AI) and/or machine learning (ML) to analyze the plurality of authentication information and/or the plurality of previously processed authentication request messages. In some embodiments, the MSRM server determines correlations between fraudulent authentication requests and differences between fraudulent and legitimate authentication requests. The authentication information can include, but is not limited to, cardholder shipping address, cardholder billing address, cardholder email address, cardholder phone number, merchant name, merchant category, merchant location, and/or at least one environment-related variable (e.g., device details, browser details) including device ID, IP address, device channel, etc. In some embodiments, the authentication information is hashed prior to storing to protect the security of this personally identifiable information.

Other authentication information can include, but is not limited to, a fraud probability score, a fraud analysis, at least one reason code, and step-up authentication results. The fraud probability score is a score representing a determined probability that the person associated with the transaction is the person associated the corresponding account, with lower scores indicating lower fraud risk and higher scores indicating higher fraud risk. In other words, the fraud probability score represents a likelihood that the suspect cardholder (e.g., the person attempting to perform a transaction) or the person attempting to access the account is the legitimate person (or cardholder) having the privileges to use the payment card to perform a payment transaction. For example, the fraud probability score may be represented by a number from 0-999 and/or by a fraud probability threshold category from 0-19. In some embodiments, fraud probability assessments that will be shared, such as through the authorization field of one or more messages, will be quantified on a scale of 0-9. Those of skill in the art will appreciate that any suitable fraud probability score may be used. In further embodiments, the transactions can also include a user attempting to access secure information on or over a computer network.

The risk analysis is a description of a level of risk corresponding to the fraud probability score (e.g., low risk, medium risk, or high risk). Further the reason codes include one or more factors that influenced the fraud probability score. In some embodiments, the reason codes are generated using reason code categories and anchors, as described herein. For example, a fraud probability score of 900 or less may be considered low risk, a fraud probability score between 900 and 980 may be considered medium risk, and a fraud probability score above 980 may be considered high risk. Those skilled in the art will appreciate that any suitable fraud probability score thresholds and any number of risk levels may be used.

The following Table 1 lists a number of example data elements that may be used for authentication. For example, at least some of these data elements may be included in the authentication information included in an authentication request, while other data elements may be otherwise generated. Those of skill in the art will appreciate that the number of data elements could include more than those listed below, and for example could include over one hundred and seventy data elements. The authentication information may also be divided by category, such as: transaction data (amount, currency, date, and time), device data (IP address, device info, and channel data), cardholder data (account number and shipping address), and merchant data (name, category, and country).

TABLE 1

| | Data Element |
|---|---|
| 1 | Requestor Authentication Information |
| 2 | Requestor Challenge Indicator |
| 3 | Requestor ID |
| 4 | Requestor Initiated Indicator |
| 5 | Requestor Name |
| 6 | Requestor Non-Payment Authentication Indicator |
| 7 | Requestor Prior Transaction Authentication Information |
| 8 | Requestor URL |
| 9 | Server Operator ID |
| 10 | Server Reference Number |
| 11 | Server Transaction ID |
| 12 | Server URL |
| 13 | Account Type |
| 14 | Acquirer BIN |
| 15 | Acquirer Merchant ID |
| 16 | Challenge Mandated Indicator |
| 17 | Counter ACS to SDK |
| 18 | HTML |
| 19 | Operator ID |
| 20 | Reference Number |
| 21 | Rendering Type |
| 22 | Signed Content |
| 23 | Transaction ID |
| 24 | UI Type |
| 25 | Address Match Indicator |
| 26 | Authentication Method |
| 27 | Authentication Type |
| 28 | Authentication Value |
| 29 | Browser Accept Headers |
| 30 | Browser IP Address |
| 31 | Browser Java Enabled |
| 32 | Browser Language |
| 33 | Browser Screen Color Depth |
| 34 | Browser Screen Height |
| 35 | Browser Screen Width |
| 36 | Browser Time Zone |
| 37 | Browser User-Agent |
| 38 | Card/Token Expiry Date |
| 39 | Cardholder Account Identifier |
| 40 | Cardholder Account Information |
| 41 | Cardholder Account Number |
| 42 | Cardholder Billing Address City |
| 43 | Cardholder Billing Address Country |
| 44 | Cardholder Billing Address Line 1 |
| 45 | Cardholder Billing Address Line 2 |
| 46 | Cardholder Billing Address Line 3 |
| 47 | Cardholder Billing Address Postal Code |
| 48 | Cardholder Billing Address State |
| 49 | Cardholder Email Address |
| 50 | Cardholder Home Phone Number |
| 51 | Cardholder Mobile Phone Number |
| 52 | Cardholder Name |
| 53 | Cardholder Shipping Address City |
| 54 | Cardholder Shipping Address Country |
| 55 | Cardholder Shipping Address Line 1 |
| 56 | Cardholder Shipping Address Line 2 |
| 57 | Cardholder Shipping Address Line 3 |
| 58 | Cardholder Shipping Address Postal Code |
| 59 | Cardholder Shipping Address State |
| 60 | Cardholder Work Phone Number |
| 61 | Challenge Additional Information Text |
| 62 | Challenge Cancelation Indicator |
| 63 | Challenge Data Entry |
| 64 | Challenge HTML Data Entry |
| 65 | Challenge Information Header |
| 66 | Challenge Information Label |
| 67 | Challenge Information Text |
| 68 | Challenge Information Text Indicator |
| 69 | Challenge Selection Information |
| 70 | Challenge Window Size |
| 71 | Device Channel |
| 72 | Device Information |
| 73 | Device Rendering Options Supported |
| 74 | DS Reference Number |
| 75 | DS Transaction ID |
| 76 | DS URL |
| 77 | Electronic Commerce Indicator |
| 78 | EMV Payment Token Indicator |
| 79 | Expandable Information Label 1 |
| 80 | Expandable Information Text 1 |
| 81 | Instalment Payment Data |
| 82 | Interaction Counter |
| 83 | Issuer Image |
| 84 | Merchant Category Code |
| 85 | Merchant Country Code |
| 86 | Merchant Name |
| 87 | Merchant Risk Indicator |
| 88 | Message Category |
| 89 | Message Extension |
| 90 | Message Type |
| 91 | Message Version Number |
| 92 | Notification URL |
| 93 | OOB App Label |
| 94 | OOB App URL |
| 95 | OOB Continuation Indicator |
| 96 | OOB Continuation Label |
| 97 | Payment System Image |
| 98 | Purchase Amount |
| 99 | Purchase Currency |
| 100 | Purchase Currency Exponent |
| 101 | Purchase Date & Time |
| 102 | Recurring Expiry |
| 103 | Recurring Frequency |
| 104 | Resend Challenge Information Code |
| 105 | Resend Information Label |
| 106 | Results Message Status |
| 107 | SDK App ID |
| 108 | SDK Counter SDK to ACS |
| 109 | SDK Encrypted Data |
| 110 | SDK Ephemeral Public Key (Qc) |
| 111 | SDK Reference Number |
| 112 | SDK Transaction ID |
| 113 | Submit Authentication Label |
| 114 | Transaction Status |
| 115 | Transaction Status Reason |
| 116 | Transaction Type |
| 117 | Why Information Label |
| 118 | Why Information Text |

In the example embodiment, transactions are categorized “fraudulent” or “genuine.” “Genuine” transactions are considered those that have been authenticated and fully processed. “Fraudulent” transactions are those that have been confirmed to be fraudulent, either during processing or afterwards. In some embodiments, “fraudulent” transactions were authenticated. In the example embodiment, one or more indicators in the authentication information indicate whether a transaction is “fraudulent” or “genuine.” One or more indicators may also indicate whether or not authentication was attempted on the transaction.

In the example embodiment, authentication and/or authorization information can include, but is not limited to, a fraud probability score and a fraud analysis. The fraud probability score is a score representing a determined probability that the person associated with the transaction is the person associated with the corresponding account, with lower scores indicating lower fraud probability and higher scores indicating higher fraud probability. In other words, the fraud probability score represents a likelihood that the suspect cardholder (e.g., the person attempting to perform a transaction) or the person attempting to access the account is the legitimate person (or cardholder) having the privileges to use the payment card to perform a payment transaction. For example, the fraud probability score may be represented by a number from 0-999. If a transaction is predicted to be fraudulent and a first model provides a validity assessment of 800 out of 999, its residue is the fraud indicator 1 times 999 minus its prediction of 800, which equals 199. The residue 199 will be used as the new target for the second stage model to learn and make minor adjustments to the original assessment. If the second stage model predicts 150, then the total validity assessment is 800 plus 150 equals 950 compared to the initial validity assessment of 800, which shows significant improvements. Also, because of the modular design of the multi-stage residue modeling approach, the second stage can be removed when there is an issue related to data quality, data coverage or performance concerns, etc., which shows the flexibility in consolidating multiple models. Those of skill in the art will appreciate that any suitable fraud probability score may be used. In further embodiments, the transactions can also include a user attempting to access secure information on or over a computer network.

In some embodiments, the authorization message is in an ISO 8583 or ISO 20022 message formats for processing over a dedicated payment processing network. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

In at least some known authentication systems, a bank that issued the payment card for the transaction (referred to as the issuer) contracts with an access control server (ACS) for authentication services. Specifically, the ACS analyzes at least some of the data associated with the transaction, determines whether or not it is likely that the alleged cardholder is, in fact, the actual or legitimate cardholder, and reports that determination to the issuer.

However, contracting with an ACS for authentication services may be relatively expensive for an issuer. Further, different issuers may contract with different ACSs. Accordingly, the amount of data that a particular ACS is able to leverage when performing authentication services may be fairly limited, as that ACS may only have access to a relatively small number of transactions. Further, at least some ACSs do not have the capability to perform more sophisticated (and thus more accurate) authentication procedures. In addition, ACSs that are able to provide some level of fraud detection capability may temporarily lose such capability (e.g., due to equipment malfunction), directly impacting their ability to successfully authenticate online users.

In at least one embodiment, the multi-stage residual modeling (MSRM) process that may be used for the authentication process enables authenticating the user as a legitimate user of secure application, or of a payment account or log-in credentials at remote website, based on interactions captured passively (e.g., captured during independent, routine activity of the user and without prompting or requiring authentication-specific actions by the user) by a passive authentication requestor, avoiding the requirement by conventional systems to ask additional questions of the user (e.g., as part of a step-up challenge) or request additional, authentication-specific inputs (e.g., facial scan) from the user. Thus, the authentication process enables authentication of the user to be maintained without diverting computing resources of computing device for multiple active authentications. The authentication process also reduces or eliminates friction inherent in the conventional authentication process.

That is, in the example embodiment, the ACS may determine to fully authenticate the transaction, deny authentication for the transaction, or perform additional authentication (e.g., by issuing a step-up challenge to the cardholder) for the transaction, based on at least one of a risk score, the risk analysis, and the reason codes.

If the transaction is medium risk, the authentication platform may issue a step-up challenge to the cardholder. Based on the results of the step-up challenge, the authentication platform may approve or deny the transaction. In some embodiments, if the transaction is medium risk, the authentication platform transmits the analysis result data to the ACS, so that the ACS will perform the step-up challenge. In other embodiments, the authentication platform may take different steps at different risk levels and have additional or fewer risk levels to analyze based on the authentication profile.

Transactions deemed safe or low risk are silently authenticated (e.g., so-called “frictionless” authentication), while higher risk transactions are subjected to step-up authentication. When a low risk transaction is silently authenticated, so much data has already been gathered that further authentication adds little to no value.

The integration of the ACS provides a number of benefits to cardholders, issuers, and merchants. It reduces risk of unauthorized transactions through an approach that incorporates a rich, comprehensive set of data to make authentication decisions. For cardholders, it provides a simple, secure, and familiar online authentication experience, regardless of payment channel or device. For issuers, it allows for “frictionless” authentication, in which an explicit cardholder step-up authentication is not required or performed. This enables more intelligent risk assessment decisions and the ability to selectively challenge the cardholder as needed.

At least one of the technical problems addressed by this system includes: (i) a lack of accuracy of authorization and/or authentication services; (ii) a lack of speed in authorization of a transaction or access to data in a real-time environment: (iii) a lack of applicability of scores applied for authorization processing; (iv) mis-classification of fraudulent transactions: (v) an inability to move authorization services between different actors: (vi) high network load and/or transaction latency caused at least in part on step-up challenging most or all card-not-present transactions, which results in network delays and reduced bandwidth: (vii) allowing fraudulent transactions to be successfully processed if there is no step-up challenge of a card-not-present transaction: (viii) consumer inconvenience during card-not-present transactions based at least in part on having to answer an additional authentication challenge during a transaction; and (ix) abandonment of transactions by consumers when faced with a step-up challenge, thus leading to lost sales for merchants and lost processing fees for the other network parties based on those abandoned transactions.

A technical effect of the systems and processes described herein is achieved by performing at least one of the following steps: (i) store a plurality of analysis models for analyzing transactions including a first model and a second model: (ii) receive a plurality of authorization data associated with a user and a transaction associated with the user; (iii) execute the first model using the plurality of authorization/authentication data to receive a first analysis score for the first model, wherein the analysis score is based on an analysis range; (iv) determine a remainder score for the first analysis score based on the first analysis score and the analysis range; (v) execute the second model using the plurality of authorization data and the remainder score to generate a second analysis score: (vi) combine the first analysis score and the second analysis score to generate the final analysis score; and (vii) return the final analysis score.

As will be appreciated, based on the description herein the technical improvement in the authorization system as described herein is a computer-based solution to a technical deficiency or problem that is itself rooted in computer technology (e.g., the problem itself derives from the use of computer technology). More specifically, fraud is a significant problem for transactions conducted over an electronic payment network, especially for card-not-present transactions. Advanced fraud detection methodologies (e.g., MSRM) are useful to process transactions more efficiently without increasing network traffic and processing load. In addition, an issuer computer device may be unavailable. Accordingly, to address this problem, the systems and methods described herein address this technical problem by using an MSRM-enabled server and MSRM engine to perform an assessment and generate results based on multi-stage residual modeling to determine a fraud score and to forward the results based on the MSRM result data to the issuer computer device to enable the issuer computer device to make an authorization decision.

The following detailed description of the embodiments of the disclosure refers to the accompanying drawings. The same reference numbers in different drawings may identify the same or similar elements. Also, the following detailed description does not limit the claims.

Described herein are computer systems such as authorization computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, OracleR Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California: IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

As used herein, the terms “payment device,” “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), wearable computing devices, key fobs, and/or any other computing devices capable of providing account information. Moreover, these terms may refer to payments made directly from or using bank accounts, stored valued accounts, mobile wallets, etc., and accordingly are not limited to physical devices but rather refer generally to payment credentials. Each type of payment device can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to users for transactions conducted over an electronic payment network.

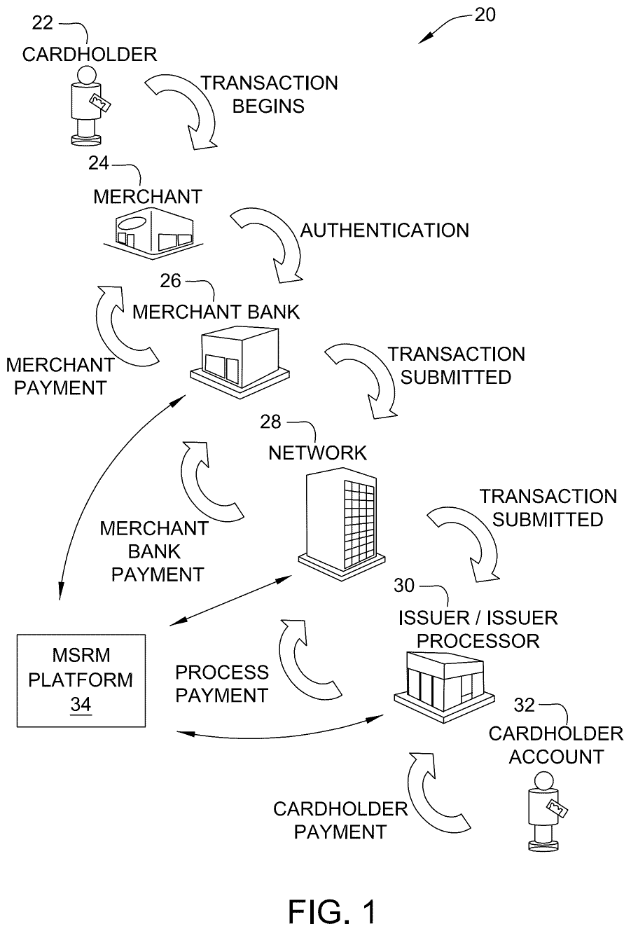

FIG. 1 is a schematic diagram illustrating an example multi-stage residual modeling (MSRM) platform 34 in communication with a multi-party payment processing system 20 for processing transactions in accordance with one embodiment of the present disclosure. FIG. 1 depicts a flow of data in a financial transaction through system 20. Embodiments described herein may relate to a transaction card system, such as a credit card payment system using the MASTERCARD® interchange network. The MASTERCARD® interchange network is a set of proprietary communications standards promulgated by Mastercard International Incorporated® for the exchange of financial transaction data and the settlement of funds between financial institutions that are members of Mastercard International Incorporated®. (MASTERCARD® is a registered trademark of Mastercard International Incorporated located in Purchase, New York).

In the exemplary transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization of the cardholder 22 and authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether the alleged cardholder is actually legitimate cardholder 22 (i.e., authentication), whether cardholder's 22 account 32 is in good standing, and whether the purchase is covered by cardholder's 22 available credit line. Based on these determinations, the requests for authentication and authorization will be declined or accepted. Authentication may be performed prior to authorization. If the requests are accepted, an authorization code is issued to merchant 24.

In the exemplary embodiment, the payment card system 20 includes or is in communication with a multi-stage residual modeling (MSRM) platform 34. In this embodiment, the MSRM platform 34 provides enhanced meta-data collection to capture information, including meta-data from the transactions processed by the payment card system 20 (e.g., authentication and/or authorization data). The MSRM platform 34 stores this meta-data to use as historical data when performing an authentication process prior to performing an authorization process. In the exemplary embodiment, the MSRM platform 34 may receive historical data from one or more of the acquirer bank 26, the interchange network 28, and the issuer 30. Examples of this data may include historical authorization and/or authentication data associated with a plurality of PANs, other historical data associated with the plurality of PANs, etc. The historical data may be associated with both card present and card not present historical transactions. For example, the historical data may include cardholder shipping address, cardholder billing address, cardholder email address, cardholder phone number, merchant name, merchant category, merchant location, and/or at least one environment-related variable (e.g., device details, browser details) including device ID, IP address, device channel, etc. Further, the historical data may be stored in a database accessible by MSRM platform 34 and operated by an interchange network 28. In some embodiments, the historical data will be hashed prior to storing to protect the security of this personally identifiable information.

The MSRM platform 34 is used to analyze the data included in an authorization or authentication request message by applying multiple models in a multi-stage residual modeling approach. The MSRM platform 34 receives an authorization request message and/or authentication request message and analyzes in real-time the data included in the request messages to determine a correlation between data included in the messages and fraud indicators that are included in the fraud modeling process. Specifically, the MSRM platform 34 applies a first classification model, and then applies one or more second stage models to the residual data (e.g., data gaps not captured by the first model) to determine a final scoring output by adding the output from the first model with the output from the second model. Then the MSRM platform 34 generates an authentication or authorization decision (e.g., approves or declines the transaction) based on the final scoring output, or provides the score along with a recommendation to a third-party (e.g., issuer or other party) by updating the authentication or authorization request message with the score data and sending the updated message to the third-party.

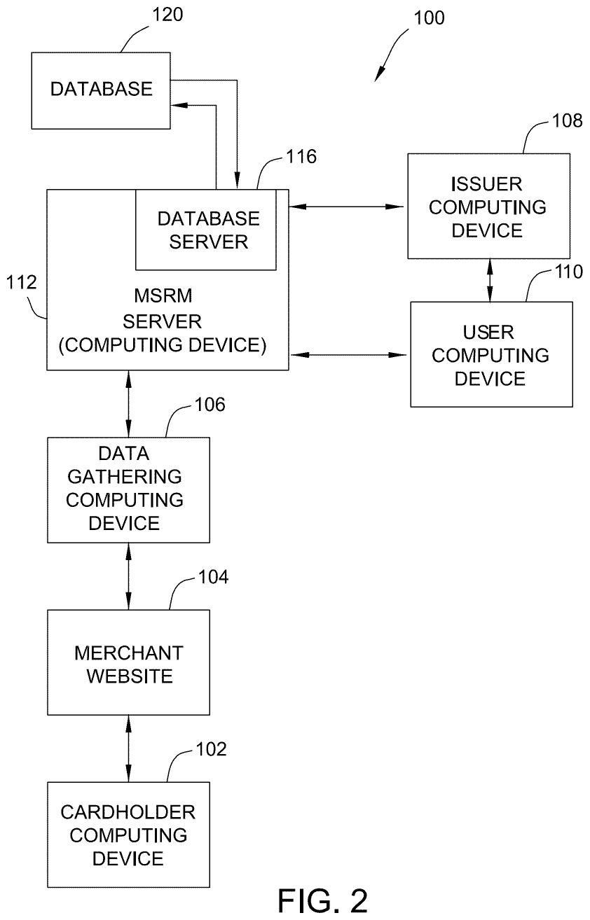

When a request for authorization is accepted, the available credit line of cardholder's 22 account 32 is decreased. Normally, a charge for a payment card transaction is not posted immediately to cardholder's 22 account 32 because bankcard associations, such as Mastercard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction may be settled between issuer bank 30 and interchange network 28, and then between interchange network 28 and merchant bank 26, and then between merchant bank 26 and merchant 24.

As described below in more detail, multi-stage residual modeling may be performed by the MSRM platform 34 on behalf of an issuer computer device or issuer bank 30 in the context of multi-party payment card system 20. Although the systems described herein are not intended to be limited to facilitate such applications, the systems are described as such for example purposes.

FIG. 2 is an expanded block diagram of an example embodiment of a computer network 100 for analyzing computer network message traffic in the processing system 20 (shown in FIG. 1). In the exemplary embodiment, network 100 may be used for multi-stage residual modeling for authenticating or authorizing transactions. In other embodiments, the network 100 may be used for authenticating and/or authorizing payment transactions using a multi-stage residual modeling approach for authenticating and/or authorizing transactions using those models. These transactions may include payment transactions as well as users attempting to access secure information over computer networks.

In the exemplary embodiment, cardholder computing devices 102 are computers that include a web browser or a software application, which enables cardholder computing devices 102 to access remote computer devices, such as merchant website 104, using the Internet or other network. More specifically, cardholder computing devices 102 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Cardholder computing devices 102 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, cardholder computing devices 102 are associated with individual cardholders 22 (shown in FIG. 1).

In the exemplary embodiment, merchant website 104 is an online shopping website that is reachable through computers that include a web browser or a software application, such as cardholder computing devices 102, using the Internet or other network. More specifically, merchant website 104 may be hosted on one or more computers that are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Computing devices hosting merchant website 104 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, merchant website 104 is associated with merchant 24 (shown in FIG. 1). In the exemplary embodiment, merchant website 104 allows cardholder 22 to purchase goods and/or services using cardholder computing device 102. In some embodiments, transactions performed through merchant website 104 are considered card not present transactions. These transactions may include users attempting to access secure information over computer networks.

In the exemplary embodiment, data gathering computer devices 106 are computers that include a web browser or a software application, which enables data gathering computer devices 106 to access remote computer devices, such as merchant website 104 and MSRM server 112, using the Internet or other network. More specifically, data gathering computing devices 106 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Data gathering computer devices 106 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, the data gathering computer devices 106 are associated with the MSRM server 112. In other embodiments, data gathering computer devices 106 are associated with acquirer bank 26 (shown in FIG. 1).

In the exemplary embodiments, multi-stage residual modeling (MSRM) server 112 is in communication with plurality of data gathering computer devices 106 and one or more issuer computer devices 108. In some embodiments, MSRM server 112 is similar to MSRM platform 34 (shown in 1). In the exemplary embodiment, MSRM server 112 receives data from the data gathering computer devices 106 and/or issuer computer devices 108 and uses that data to analyze transactions. In some embodiments, the MSRM server 112 receives data from the data gathering computer devices 106 and/or issuer computer devices 108 and uses that data to perform authorization of transactions, such as payment transactions and users attempting to access secure information. In some embodiments, MSRM server 112 performs authorization with issuer computer devices 108 (30 shown in FIG. 1). In other embodiments, MSRM server 112 replaces the issuer bank 30 in the authorization process. In the exemplary embodiment, MSRM server 112 is associated with the interchange network 28 (shown in FIG. 1). In other embodiments, the MSRM server 112 is merely in communication with the interchange network 28.

In the exemplary embodiment, issuer computing devices 108 are computers that include a web browser or a software application, which enables issuer computing devices 108 to access remote computer devices, such as MSRM server 112, using the Internet or other network. More specifically, issuer computing devices 108 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Issuer computing devices 108 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, issuer computing devices 108 are associated with the issuer 30.

In the exemplary embodiment, user computing devices 110 are computers that include a web browser or a software application, which enables user computing devices 110 to access remote computer devices, such as MSRM server 112, using the Internet or other network. More specifically, user computing devices 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computing devices 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 116 is connected to database 120. In one embodiment, centralized database 120 is stored on server system 112 and can be accessed by potential users at one of user computing devices 110 by logging onto MSRM server 112 through one of client systems. In an alternative embodiment, database 120 is stored remotely from MSRM server 112 and may be non-centralized. Database 120 may be a database configured to store information used by MSRM server 112 including, for example, historical transaction records, including both payment transactions and users attempting to access secure information.

Database 120 may include a single database having separated sections or partitions, or may include multiple databases, each being separate from each other. Database 120 may store transaction data generated over the processing network including data relating to merchants, consumers, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authentication and authorization request data. Database 120 may store one or more authorization profiles, where each authorization profile includes one or more authorization rules, one or more fraud probability level thresholds, and one or more routing rules based on the fraud probability level thresholds. In the exemplary embodiment, database 120 may store one or more determined rules. Furthermore, the database 120 may also store classification models, thresholds and/or preferences. These models, thresholds and/or preferences may be set by a user with a user computing device 110.

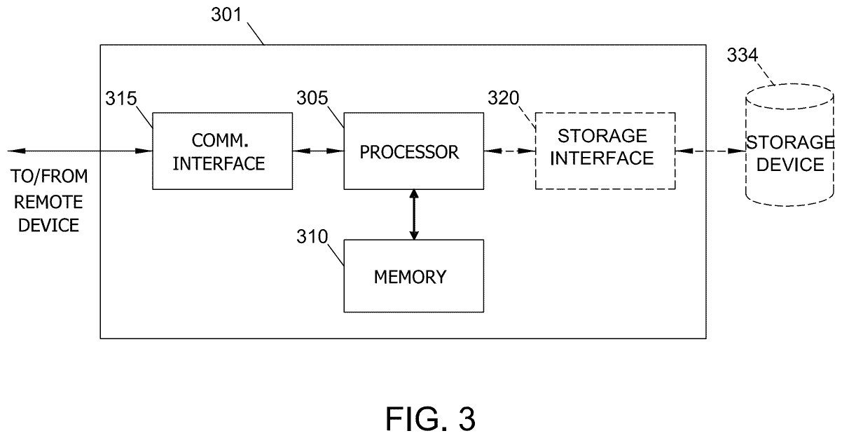

FIG. 3 illustrates an example configuration of a server system 301 such as MSRM platform 34 (shown in FIG. 1), in accordance with one example embodiment of the present disclosure. Server system 301 may also include, but is not limited to, merchant website 104, data gathering computer device 106, issuer computer devices 108, issuer computing device 108, MSRM server 112, and database server 116 (all shown in 2). In the example embodiment, server system 301 determines and analyzes characteristics of devices used in transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from a via the Internet, as illustrated in FIG. 2.

Processor 305 may also be operatively coupled to a storage device 334. Storage device 334 is any computer-operated hardware suitable for storing and/or retrieving data. In some embodiments, storage device 334 is integrated in server system 301. For example, server system 301 may include one or more hard disk drives as storage device 334. In other embodiments, storage device 334 is external to server system 301 and may be accessed by a plurality of server systems 301. For example, storage device 334 may include multiple storage units such as hard disks or solid state disks in a redundant array of inexpensive disks (RAID) configuration. Storage device 334 may include a storage area network (SAN) and/or a network attached storage (NAS) system.

In some embodiments, processor 305 is operatively coupled to storage device 334 via a storage interface 320. Storage interface 320 is any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

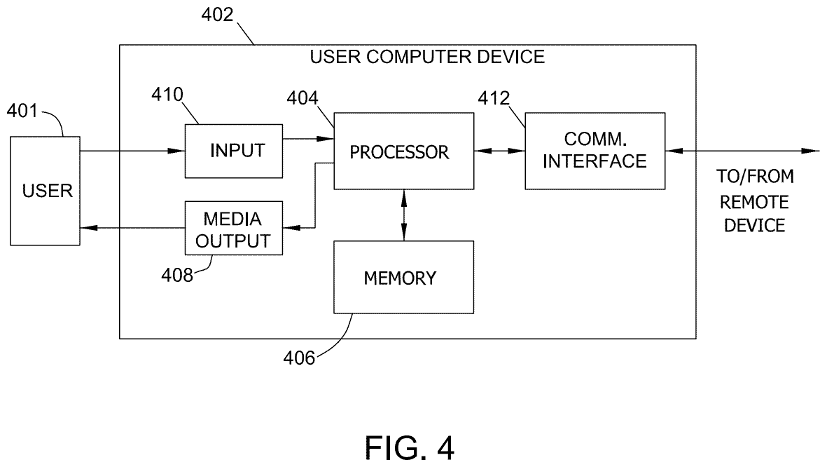

FIG. 4 illustrates an example configuration of a client computing device 402. Client computing device 402 may include, but is not limited to, cardholder computing device 102 (shown in FIG. 1), merchant website 104, data gathering computer device 106, and user computing device 110 (all shown in FIG. 2). Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400. Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 301 or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

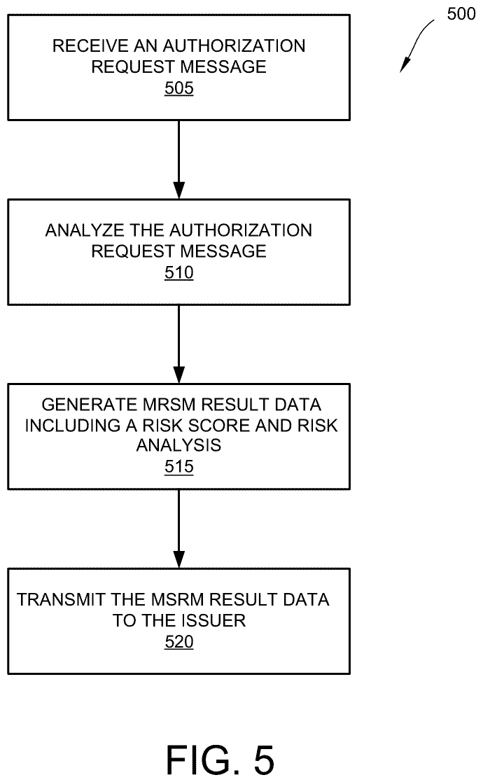

FIG. 5 is a flow diagram of an example method 500 for authorizing an online user on behalf of a MSRM network 100 (shown in FIG. 2). In the exemplary embodiment, the steps of method 500 are performed by the MSRM server 112 (shown in FIG. 2).

In the exemplary embodiment, the method 500 includes the following steps performed by the MSRM server 112. Method 500 includes receiving 505, from a sender in communication with a merchant website, an authorization request message for authorizing a transaction, the authorization request message includes authorization data (authentication data or meta data may also be collected) collected from a user computing device during an online interaction with the merchant website. In at least some embodiments, the online interaction includes a transaction, which is a payment card transaction. In some other embodiments, the transaction can include, but is not limited to, debit card transactions, ATM (automated teller machine) transactions, card present transactions, card not present transactions, and/or any other type of transaction that the user and/or network 100 wishes to analyze. Method 500 further includes analyzing 510, at least in part on the authorization data, the authorization request message, by performing a fraud or validity assessment using an authentication response and/or authorization response received from an issuer computing device by the merchant website. In some embodiments, the transaction is associated with a single issuer 30 (shown in FIG. 1). In other embodiments, the transaction is associated with a specific period of time (i.e., Black Friday, last weekend before Christmas, before school starts), a specific geographic area, a particular merchant 24 or merchant bank 26 (both shown in FIG. 1), and/or any other attributes that the user wishes to filter the transactions by.

Method 500 further includes the MSRM server 112 generating MSRM result data 515 including a validity score and validity analysis using a compromise assessment to the authorization data. In some embodiments, the MSRM result data may be stored in a database, such as database 120 (shown in FIG. 2) and later retrieved. A classification model is embedded into the authorization request message generated during the online interaction and routed to a decisioning server via a payment network. The authorization request message formatted according to a set of proprietary communications standards promulgated by the payment network for exchange of data between institutions that are members of the payment network.

Further, method 500 includes the MSRM server 112 transmitting 520 the embedded or enhanced authorization request including a fraud score, to the issuer to enable the issuer computer device to make an authorization decision. The authorization decision may be one of an authorization approval, and an authorization denial from the issuer based on the fraud or validity assessment by the sender. Further, prior to receiving the authorization request message, a message may be received from the sender relating to the online interaction associated with the online interaction, the message may include a predefined sender confidence level data field that includes a fraud assessment of the online interaction by the sender.

In some embodiments, the transaction could be received as an authorization request. The authorization request could include additional information, such as, but not limited to, a fraud score, a reason code, and/or a fraud level. The additional information could have been calculated by a different computer device in the system 20 (shown in FIG. 1), such as, but not limited to, the merchant 24, merchant bank 26, interchange network 28, and/or issuer 30. The MSRM server 112 may receive 505 the transaction from one of the merchant 24, merchant bank 26, interchange network 28, and/or issuer 30.

Based on the MSRM result data, the MSRM server 112 determines whether or not to authorize the transaction. The MSRM server 112 then outputs its decision to one or more devices in the system 20. The MSRM result data includes whether the transaction was fraudulent or genuine.

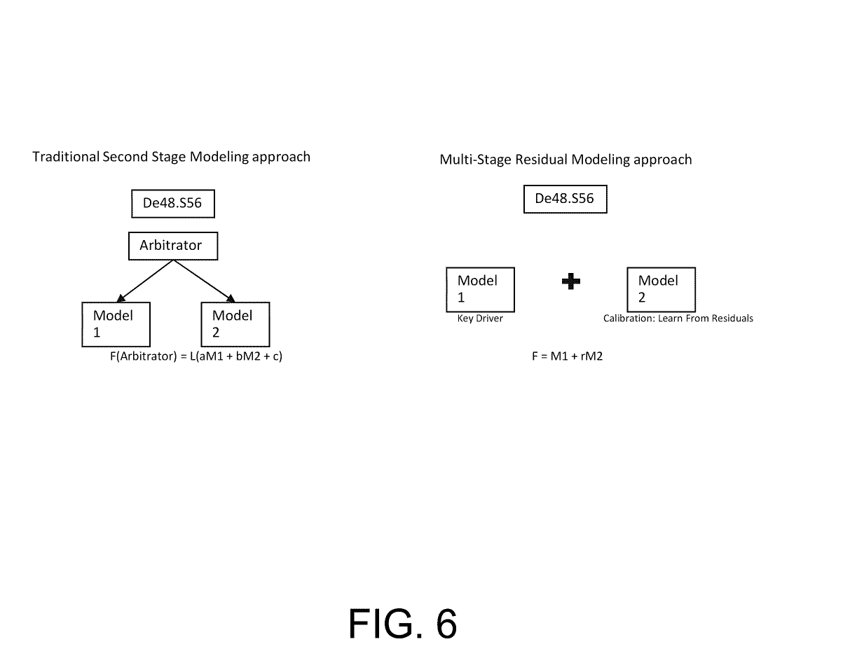

FIG. 6 is an example schematic diagram illustrating a transaction flow in using the MSRM system 200 (shown in FIG. 2). In the exemplary embodiment, the steps of the method 500 are performed by the MSRM server 112 (shown in FIG. 2).

In the exemplary embodiment, the diagram shows a comparison between a traditional second stage modeling approach (left side) and a multi-stage residual modeling (MSRM) approach (right side). Both approaches include a field in an authorization message. For example, the field is Data Element 48.S56. This field is used as a signal to issuers on the data side. The field is part of an ISO message, which is a data element received and inputted into the results from a residual fraud score. While an authorization message is shown in FIG. 6, one having skill in the art would understand that an authentication message could be used and/or any other system where multiple models may be used.

One difference in approaches is an arbitrator in the traditional second stage model. In the traditional second stage modeling approach, an arbitrator is used to stack model 1 and model 2. The following equation shows the mathematics associated with a second stage modeling approach.

F(Arbitrator)=L(aM1+bM2+c), where F is a function, L is a function (loss), coefficients a and b are applied to each of model 1 (M1) and model 2 (M2), and coefficient c is added.

For the traditional approach: (i) a model's importance depends on coefficients and arbitrator: (ii) model is less flexible in deployment (requires model refresh for arbitrator); (iii) model has complicated hierarchy for connected intelligence; and (iv) there is competition and conflict.

Computation is required for the other model, namely a regression that determines what a, b, and L will be in different models. If model one is different, then model two is different, or if model one is refreshed, then model two should be refreshed. a, b, c are all variables. They are not static. Here, they present a function which is Arbitrator. Arbitrator from a mathematics perspective is a function, from the model perspective it can be any kind of model. The models will determine a, b, c here. These are parameters or estimations.

A difference between the traditional approach and the residual model approach is there is no parameter before model one, which is a key driver. Things learned from the residuals, only determine the parameter path here, and also the target is different. The target for model one and model two is always binary indicator fraud, because they are competing with each other to decide which one makes more sense. Here, since it is assumed model one is the key driver, for model two the target is the gaps between model one's prediction and the ground truth. Enhancement and collaboration can be seen because if model one makes a perfect prediction, there is no room for an improvement and model two is not stepping. Because in this case, the co-efficiency in an ideal situation would be zero which still keeps the perfect prediction from the key driver. Unless, there is a gap between model one's prediction and ground truth. For example, if a target is 999 and model one has 800 as the prediction, there is a gap of 199. This will be the target of additional signals to mitigate these gaps. If the second model makes a prediction of 190, then prediction is totaled, because they will be summed up eventually. It would be about 990 compared to the ground truth 999, which is closer. That is a difference between the traditional approach and the multi-stage residual modeling approach. For example, in the traditional approach, if model one makes a prediction of 800, then model two makes a prediction of 199, then the arbitrator may work to determine a blended score coming out of these two predictions because of the opposite risk levels of these two models compared against the ground truth or actual fraud. The two predictions have different opinions. However, there is no such competition conflict in the residual model approach, as long as there is a gap, a residual and model two steps in, otherwise key drivers are kept in untouched or ideal scenarios.

As discussed above, a, b, and c are co-efficiencies, while L is a function. L is traditionally used as a loss function, but it can be any kind of function eventually. You can see L is in the equation on the left side (traditional approach), but not in the equation on the right side (residual model approach). L is a function on top of M1 and M2. On the right side, these kinds of conflicts and/or complexities do not exist on top of M1 and M2. M1 is kept as a key driver and something is blended or applied on M2.

L here can be a regressive function. A regressive function is an accommodation of these parameters, but L can be any other function as well. So, L is a model. L's arbitrator is a function built on top of M1 and M2. These things are not provided on the right side (residual model approach) because a lesser model is not built on top of M1. M2 is an add on, or in addition to M1. On the left side, the L function can be an average of the score of M1 and M2 on a simple approach-a simple aggregation. On the right side, there is no average because M2 is applied to the residual.

For example, if the high score is 999 on both sides, M1 indicates 800, M2 indicates 199, and on the left side B×M1 or B×M2+ the N is used. It is a mathematical transformation to get as close to 999 as possible. On the right side, if M1 indicates 800 and M2 indicates 199, then it will be close to the target, 999. Because M1 has 800, almost 199 gaps here, as the residual. M2 will make sure it can fill in the gaps to be close to the target 999. No other mathematical transformation is necessary here to determine if M1 indicates 800 or M2 indicates 199. The intention is different. In the traditional second stage way, decisions are made to determine which one may weigh in, or the arbitrator thinks which one is correct. However, improvements can be learned from the residuals. The mission is to fill in the gaps. If there are no gaps, then the M2 model does not need to do anything. But, if there is a gap, the mission is to fill in this gap.

Another difference in approaches is a transformation of mathematics. The models use the same target, which is actual fraud. In a multi-stage residual modeling approach, model 1 is a key driver and model 2 is calibrated by learning from residuals. If there are any additional signals or compromise assessments (compromise of validity-based events) identified, they will be incorporated into the key driver. Residuals are calculated gaps, or a validity assessment that is not fully predicted by the key driver. The following equation shows the mathematics associated with a multi-stage modeling approach where no arbitrator is used.

F=M1+rM2, where F is a function, model 1 is M1 and model 2 is M2, and r is the residual.

Residuals are any validity/compromised detection assessment not successfully predicted by the key model, which are added to the target of the next model, and compared to the basic case.

For the residual modeling approach: (i) the overall model mainly depends on the key driver with optional second stage residual models for calibration: (ii) the overall model is more flexible in deployment: (iii) the overall model has a modular design: (iv) the model has connected intelligence (NuData, Ekata, etc.); (v) the overall model has better regional calibrations; and (vi) the overall model provides collaboration and improvement.

The first model predicts 800 and a target, if it is one, upper bound 999 is used minus a prediction, and the gaps—the residuals here—were used as the target for the next model. The relationship here, is the sum of those two predictions, which avoids the competing and complicated situations in the arbitrator. There is another layer of complexity here, or arbitrator, to make these two models work together. A more intuitive understanding is provided as compared to the mathematical definition. The mathematic information discusses the same things in a formula way, and the residual is what is a true target minus what comes from the first modeling prediction. These will be used as the new target for the additional signals (compromise and/or validity events) identified. Eventually the M1 will be added to the M2 to be summed up. As compared to a traditional way, where there is another layer of complications here to use the arbitrator to decide the blended score. In terms of the applications or characteristics, the first one depends on how the arbitrator makes the decision. If model one indicates the score is high and model two indicates it is low, the approach depends on an arbitrator to make the decision to choose the score range after the mix of the two. In the residual modeling approach, the relationship does not change. There is no modeling on top of the sum of these two parts. The collaboration between these two models will reduce conflicts between the two, because if model one indicates the score is high, and model two thinks the score is low, the model two will trend against the gaps. Whenever there is a gap, model two is stepping in. If there are no gaps, the key driver will be kept as the key contributor here, and model two is not stepping in as much as there is a significant gap between the ground truth and the key drivers. In terms of the applications, it is not new data, but information integrated into existing scores. Also, regional calibrations blend global networking insight with domestic insight so that this approach can be applied in these cases. Because of the hierarchy of the relationship changed from the traditional way to a residual model approach, if anything unexpected happens on model two, it can always be struck down because of the modular design compared to the first model from this hierarchy. On the performance perspective, another layer of complexity is provided here because the arbitrator has to be considered and how it is constructed from the performance perspective. The first one has the characteristic of competition and conflicts and the second one carries calibrations and collaborations.

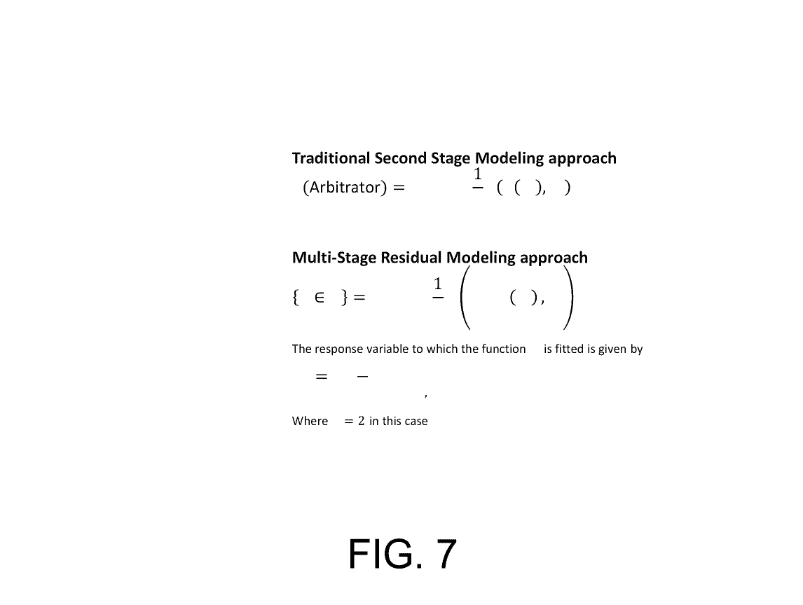

FIG. 7 is an example schematic diagram illustrating the supporting mathematics used in the transaction flow shown in FIG. 6. In the exemplary embodiment, the diagram shows a comparison between a traditional second stage modeling approach and a MSRM multi-stage residual modeling approach.

In the exemplary embodiment, the diagram shows a comparison between a traditional second stage modeling approach (top) and a MSRM multi-stage residual modeling approach (bottom). A mathematical definition for a traditional second stage modeling approach is represented by the following formula.

$$f ( Arbitrator ) = argmin \frac{1}{n} L ( f ( {x}_{i} ) , {y}_{i} )$$

A mathematical definition for a multi-stage residual modeling approach is represented by the following formula.

$$\{ f ∈ F \} = argmin \frac{1}{n} L ( {\sum }_{k = 1}^{K} f ( {x}_{i} ) , {y}_{i} )$$

For the response variable the function yᵢ is fitted is given by

$${r}_{i j} = {y}_{i} - {\sum }_{k = 1 , k \neq j}^{K} {f}_{k}$$

Where K=2 in this case.

An existing model will be the key driver. Any additional models or signals would be added on to the output of the existing model. Accordingly, the approach is not limited to model two (when K=2), it can be extended to model three, model four, by just adding additional parameters behind the formula. Also, additional models can be added, for example, model three, model four in the bracket. For example, if model three is added, model three would be used to determine whether there are any residuals coming out of the sum of the first two models. Ideally, there are no residuals—there are no gaps. If there are any gaps, model three is stepping in and an improvement can be made. If there are models 1, 2, 3 here—one indicates high, one indicates low—then model three may indicate medium risk and relay this on to the arbitrator to make the decision. Model one in the traditional approach is exactly the same as model one in the residual model approach. The only difference is the relationship or the way they are blended together. The ultimate goal is a fraud determination for the transaction.

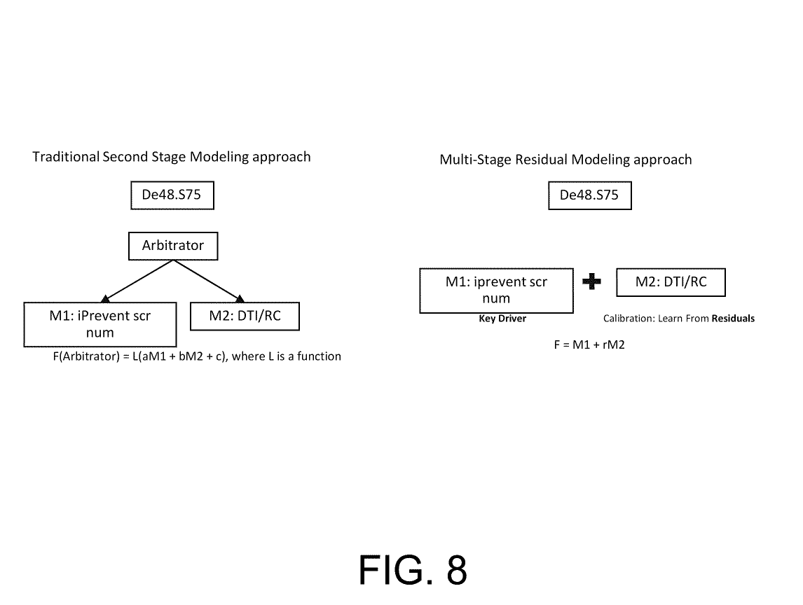

FIG. 8 is another example schematic diagram illustrating transaction flow in using the MSRM system 100 (shown in FIG. 2). In the exemplary embodiment, the steps of the method 500 are performed by the MSRM server 112 (shown in FIG. 2).

In the exemplary embodiment, the diagram shows another comparison between a traditional second stage modeling approach (left side) and a MSRM multi-stage residual modeling approach (right side). Both approaches include a field in an authorization message. For example, the field is Data Element 48.S75. This field is used as a signal to issuers on the data side. The field is part of an ISO message, which is a data element received and plugged into the results from the residual. While an authorization message is shown in FIG. 8, one having skill in the art would understand that an authentication message could be used and/or any other system where multiple models may be used.

One difference in approaches is an arbitrator in the traditional second stage model. In the traditional second stage modeling approach, an arbitrator is used to stack model 1 and model 2. The following equations shows the mathematics associated with a second stage modeling approach.

F(Arbitrator)=L(aM1+bM2+c), where F is a function, L is a function (loss), coefficients a and b are applied to each of model 1 (M1) and model 2 (M2), and coefficient c is added.

For the traditional second stage modeling approach: (i) model importance depends on coefficiencies and arbitrator; (ii) model is less flexible in deployment (requires model refresh for arbitrator); (iii) model has complicated hierarchy for connected intelligence; and (iv) there is competition and conflict (i.e., M1 and M2 have opposite validity/compromised detection assessments).

In FIG. 8, M1 is assumed to be an iPrevent scr num (i.e., a score number, also referred to as deficient intelligence), a score or decision, and M2 is a decision transaction site (DTS), or a decision transaction indicator (DTI)/reason code (RC). Recent codes are used for M2 and can be mixed them together. Some specific signals are applied to transaction level scenarios and also a validity/compromise assessment.

Here, in FIG. 8, two insights are mixed together, M1 and M2. This is a similar approach to FIG. 6 except specific data points are used, i.e., score, to plug in for M1 and M2. The decision score will populate DE48S75 originally and that score number is the foundation of DE48S75. The foundation means this is a basic version. Some add-ons are available that are built on top of the foundation with some enhancement, and then it will populate the DE48S75. The result of the calculation gets plugged into DE48S75. The data element is used as a validity assessment at the transaction level. Behind the scenes, the basic version is for the key driver in the iPrevent score number. Additionally, there is some enhancement, some specifics built on top of the score number to populate this field. The DE48S75 is not exactly the same as the iPrevent score number because there are some add-ons or enhancement.

The same approach on the right side of FIG. 8 is applied as in FIG. 6 by applying the DTI to RC ratio to the residual, add it to the iPrevent score, then plug that in to the DE48S75 data field, and provide that to the issuer so the issuer can add an enhanced fraud score. The following equation shows the mathematics associated with a multi-stage modeling approach where no arbitrator is used.

$$F = M 1 + r M 2$$

Residuals are any validity/compromised detection assessment not successfully predicted by the key model, are added to the target of the next model, compared to the basic case.

For the multi-stage residual modeling approach: (i) model mainly depends on the key driver with optional second stage residual models for calibration: (ii) model is more flexible in deployment: modular design; (iii) model has simple hierarchy for connected intelligence; and (iv) model uses collaboration rather than competition or conflict.

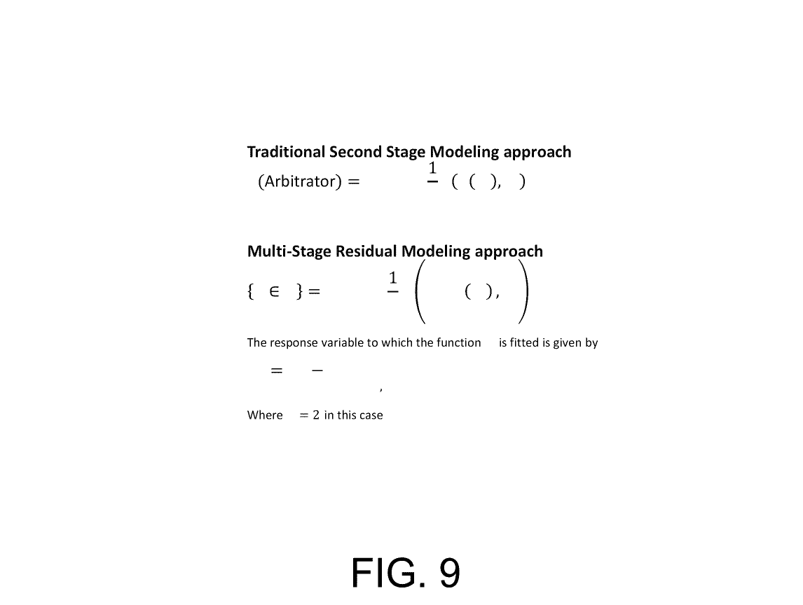

FIG. 9 is an example schematic diagram illustrating mathematics in using the transaction flow shown in FIG. 8. In the exemplary embodiment, the diagram shows a comparison between a traditional second stage modeling approach and a MSRM multi-stage residual modeling approach.

In the exemplary embodiment, the diagram shows a comparison between a traditional second stage modeling approach (top) and a MSRM multi-stage residual modeling approach (bottom). A mathematical definition for a traditional second stage modeling approach is represented by the following formula.

$$f ( Arbitrator ) = argmin \frac{1}{n} L ( f ( {x}_{i} ) , {y}_{i} )$$

A mathematical definition for a multi-stage residual modeling approach is represented by the following formula.

$$\{ f ∈ F \} = argmin \frac{1}{n} L ( {\sum }_{k = 1}^{K} f ( {x}_{i} ) , {y}_{i} )$$

The response variable to which the function yᵢ is fitted is given by

$${r}_{i j} = {y}_{i} - {\sum }_{k = 1 , k \neq j}^{K} {f}_{k}$$

Where K=2 in this case

Technical benefits include improved performance by leveraging the multi-stage residual modeling approach from the fraud detection perspective. The performance improvement is not just with numbers, but, it is also related to the calibrations and reducing competition and conflicts. Because it is a model design, the performance environment results in reducing another layer of hierarchy. There are additional advantages in operation, model performance, and the product designs. Further, several complicated mathematical calculations are eliminated from the function approach, removing an additional layer of hierarchy, which is the arbitrator layer.

The multi-stage residual modeling approach can accommodate some scenarios, for example, and has acquisition conflicts to feed into sites/size. There is always a chance one product indicates a high risk and another indicates a low risk. This is an approach as to how to mitigate that scenario. In addition, there are always some on-soil requirements that require the combination of global network and domestic insights. For example, in India, an insight for the global network is a key driver. The India domestic insight can be added on top to accommodate the risk assessment in India.

For connected intelligence, in a situation where one score is high and one score is low, the formula focuses on the key driver to generate a score. In other words, there is no need to figure out how to average those two scores together. Instead, the residual model has been selected and, adding on to the model. It is set to address any gaps or discrepancies between the key driver's prediction and the ground truth.

In a previous example, if the target is 999, and one score indicates 800, then the gap is 199. In another example, the ground truth of the transaction is generating is supposed to be zero, but the key driver indicates a score of 800. Then the gap here is minus 800 because zero minus M1's prediction is used. M2 should step in and mitigate this possibility, this gap. M2 will try as hard to make a prediction for example, maybe 799, and make sure the sum of those two will be as close to zero as the ground truth. In the opposite direction, then the idea of the principle is the same. Whenever there are gaps of residuals, additional insight will step in. If the key driver makes the perfect prediction, there is no need to choose to average those two, or which score should win.

Regarding comparing the key driver to ground truth, this is applied to transactions that are known to be fraudulent or are not fraudulent. Accordingly, the scores is going to either be 999 or 0.

Model 1 is the key driver because add-ons are included with existing solutions with the hopes that an improvement can be provided. In real world applications, there is always an existing solution where the key driver is based on solutions. Then, a determination is made whether provided add-ons for enhancement. The difference is it does not matter how these two or three are combined.

The key driver has been available and if there are additional signals, or additional models, some lift can be provided. The key driver is similar to an insight element that is important, for example, it is a cross-border transaction and therefore that is the key driver.

M1 is the key driver because the approach is based on this key driver to fill in the gaps between the prediction and the ground truth. M1 here is an existing solution. M2 here is an add-on, i.e., additional signals or components. Because the relationship of those two is somewhat competitive and sometimes conflicting with each other, which is totally different from the right side in FIG. 9, because of the gaps from M1, this is a key driver. But, here, the gaps of M1 and the gaps of M2 are not learned. They are predictions to provide a best guess. Their relationship somewhat competes with each other or has opposition. This one thinks the gaps or residuals were learned from the M1, so there is a different key driver. In FIG. 9, M1 from the left side or right side the other existing solutions, M2 is includes additional signals or insights.

An example of a key driver can be seen with the iPrevent score number. This is the transaction level on both sides. It is believed to be a key driver, and this is also an existing solution. On the left side of FIG. 9 is the same as the key driver in an existing solution. Here is the key driver because the gaps from M1 iPrevent score numbers are learned. On the left side they are just left to compete. The iPrevent score number, the key driver, would be a strong indicator as to a likelihood or unlikelihood of the transaction being fraudulent or not. That is what is meant by the key driver on the right side of FIG. 9.

As in previous examples, there is a key driver for 800, which is the first component. It is left as it is, and any co-efficiencies cannot be applied to make it more important or less important. Something is an add-on on top of 800. So, it is assumed to be a key driver. Because on the left side is totally different in FIG. 9. If M1 is 800, 0.1 co-efficiency can be used here because essentially these two compete with each other. It would be larger if M1 made more contributions then, M1 would be larger. On the left side of FIG. 9, the key driver is the arbitrator or decision-maker. On the left side of FIG. 9, several model scores are added together in a way that can be very easy of very complicated in order to generate an output.

In one interpretation that is not used for the validity assessment and also in that interpretation if regression of prediction is seen per person, it will be used for the classification of payment validity assessment. The math formula is always the same, and is just a matter of application scenarios.

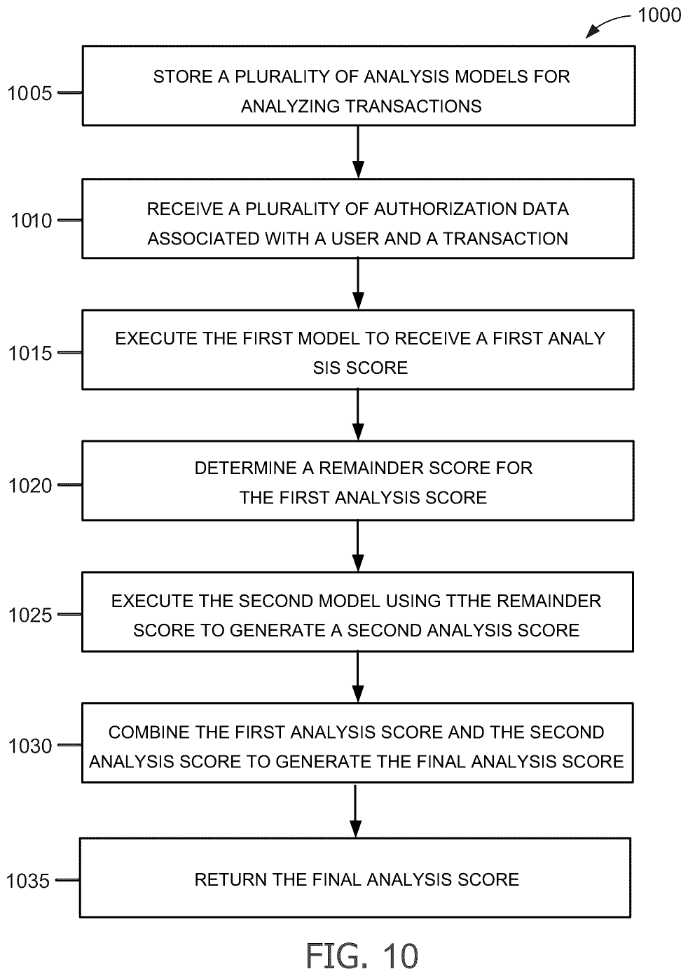

FIG. 10 is a flow diagram of an example method 1000 for modeling authorization for an online user on behalf of a MSRM network 100 (shown in FIG. 2). In the exemplary embodiment, the steps of method 1000 are performed by the MSRM server 112 (shown in FIG. 2).

In the exemplary embodiment, the MSRM server 112 stores 1005 a plurality of analysis models for analyzing transactions including a first model and a second model.

In the exemplary embodiment, the MSRM server 112 receives 1010 a plurality of authorization data associated with a user and a transaction associated with the user. In some embodiments, the plurality of authorization data may include a plurality of authentication data from authenticating the user. In some further embodiments, the plurality of authorization data is received in an authorization request message. The plurality of authorization data may include data collected from a user computing device during an online interaction, such as a payment transaction, over a computer network.

In the exemplary embodiment, the MSRM server 112 executes 1015 the first model using the plurality of authorization data to receive a first analysis score for the first model, wherein the analysis score is based on an analysis range. For example, the analysis range may be from 0 to 999 and the first analysis score may be 750.

In the exemplary embodiment, the MSRM server 112 determines 1020 a remainder score for the first analysis score based on the first analysis score and the analysis range. In the example, where the first analysis score is 750 the remainder score would be 249. In the exemplary embodiment, the MSRM server 112 executes 1025 the second model using the plurality of authorization data and the remainder score to generate a second analysis score. The second analysis score is within a range based on the remainder score. In the above example, the second analysis score is between 0 and 249, for example 150.

In the exemplary embodiment, the MSRM server 112 combines 1030 the first analysis score and the second analysis score to generate the final analysis score. The final analysis score is within a range based on the analysis range. So in the above example, the final analysis score would be 900, between 0 and 999.

In the exemplary embodiment, the MSRM server 112 returns 1035 the final analysis score. In some embodiments, the MSRM server 112 returns 1035 the final analysis score to an issuer computer device 108 (shown in FIG. 2), such as part of an authorization response message. In still further embodiments, the final analysis score is a fraud score that represents a likelihood of fraud associated with the transaction.

In some embodiments, the MSRM server 112 determines a second remainder score based on the first analysis score, the second analysis score, and the analysis range. The MSRM server 112 executes a third model of the plurality of models using the plurality of authorization data and the second remainder score to generate a third analysis score. The MSRM server 112 combine the first analysis score, the second analysis score, and the third analysis score to generate the final analysis score.

In still further embodiments, the MSRM server 112 determines whether or not to authorize the user based in part on the final analysis score. The MSRM server 112 may act as an ACS as described herein.

In additional embodiments, the MSRM server 112 determines whether or not to present a step-up challenge to the user via a user computer device based on the final analysis score.

In at least some known authentication systems, a bank 30 (shown in FIG. 1) that issued the payment card for the transaction (referred to as the issuer) contracts with an access control server (ACS) for authentication services. Specifically, the ACS analyzes at least some of the data associated with the transaction, determines whether or not it is likely that the alleged cardholder is, in fact, the actual or legitimate cardholder, and reports that determination to the issuer. In these embodiments, the MSRM server 112 acts as an ACS server.

However, contracting with an ACS for authentication services may be relatively expensive for an issuer. Further, different issuers 30 may contract with different ACSs. Accordingly, the amount of data that a particular ACS is able to leverage when performing authentication services may be fairly limited, as that ACS may only have access to a relatively small number of transactions. Further, at least some ACSs do not have the capability to perform more sophisticated (and thus more accurate) authentication procedures. In addition, ACSs that are able to provide some level of fraud detection capability may temporarily lose such capability (e.g., due to equipment malfunction), directly impacting their ability to successfully authenticate online users.

In at least one embodiment, the multi-stage residual modeling (MSRM) process may be used for the authentication process enables authenticating the user as a legitimate user of secure application, or of a payment account or log-in credentials at remote website, based on interactions captured passively (i.e., captured during independent, routine activity of the user and without prompting or requiring authentication-specific actions by the user) by passive authentication requestor, avoiding the requirement by conventional systems to ask additional questions of the user (e.g., as part of a step-up challenge) or request additional, authentication-specific inputs (e.g., facial scan) from the user. Thus, authentication process enables authentication of the user to be maintained without diverting computing resources of computing device for multiple active authentications. The authentication process also reduces or eliminates friction inherent in the conventional authentication process.

That is, in the example embodiment, the ACS may determine to fully authenticate the transaction, deny authentication for the transaction, or perform additional authentication (e.g., by issuing a step-up challenge to the cardholder) for the transaction, based on at least one of a risk score, the first analysis score, the second analysis score, the final analysis score, the risk analysis, and the reason codes.

If the transaction is medium risk, the authentication platform may issue a step-up challenge to the cardholder 22. Based on the results of the step-up challenge, the authentication platform may approve or deny the transaction. In some embodiments, if the transaction is medium risk, the authentication platform transmits the analysis result data to the ACS, so that the ACS will perform the step-up challenge. In other embodiments, the authentication platform may take different steps at different risk levels and have additional or fewer risk levels to analyze based on the authentication profile.

Transactions deemed safe or low risk are silently authenticated (i.e., so-called “frictionless” authentication), while higher risk transactions are subjected to step-up authentication. When a low risk transaction is silently authenticated, so much data has already been gathered that further authentication adds little to no value.

The integration of the ACS provides a number of benefits to cardholders, issuers, and merchants. It reduces risk of unauthorized transactions through an approach that incorporates a rich, comprehensive set of data to make authentication decisions. For cardholders, it provides a simple, secure, and familiar online authentication experience, regardless of payment channel or device. For issuers, it allows for “frictionless” authentication, in which an explicit cardholder step-up authentication is not required or performed. This enables more intelligent risk assessment decisions and the ability to selectively challenge the cardholder as needed.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing transaction and authentication data, and detecting and analyzing fraud probabilities.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for multi-stage residual modeling for authorizing an online user, the computer system comprising:
at least one memory device; and
at least one processor coupled to the at least one memory device, the at least one processor programmed to:
store a plurality of models for analyzing transactions including a first model and a second model;
receive a plurality of authorization data associated with a user and a transaction associated with the user;
execute in real-time the first model using the plurality of authorization data to receive a first output for the first model, wherein the first output is within an output range;
determine a remainder from the first model based on the first output and the output range;
execute the second model using the plurality of authorization data and the remainder to generate a second output;
combine the first output and the second output to generate a final output; and
return in real-time the final output for decisioning on whether to authorize the transaction.

2. The computer system of claim 1, wherein the plurality of authorization data includes a plurality of authentication data collected from a user computing device during an online interaction for authenticating the user.

3. The computer system of claim 1, wherein the plurality of authorization data is received in an authorization request message.

4. The computer system of claim 3, wherein the plurality of authorization data includes data collected from a user computing device during an online interaction over a computer network.

5. The computer system of claim 1, wherein a score included in the second output is within the output range and is based on the remainder.

6. The computer system of claim 1, wherein the final output includes a final score that represents a likelihood that the user is a legitimate account holder associated with an account used to initiate the transaction, wherein the final score is within the output range.

7. The computer system of claim 1, wherein the at least one processor is further programmed to:
determine a second remainder based on the first output, the second output, and the output range:
execute a third model of the plurality of models using the plurality of authorization data and the second remainder to generate a third output; and
combine the first output, the second output, and the third output to generate the final output.

8. The computer system of claim 1, wherein the at least one processor is further programmed to determine whether to authorize the transaction initiated by the user based in part on the final output.

9. The computer system of claim 1, wherein the final output includes a final score that is based on the first output and the second output, wherein the second output is a residual-based model, and wherein the final score represents a likelihood of fraud associated with the transaction, and wherein the at least one processor is further programmed to decline the transaction if the final score meets a threshold level.

10. The computer system of claim 9, wherein the at least one processor is further programmed to cause a step-up challenge to be displayed to the user via a user computer device if the final score meets another threshold level.

11. A computer-implemented method for multi-stage residual modeling for authorizing an online user, the method implemented on a computing device comprising at least one memory device coupled to at least one processor, the method comprising:
storing a plurality of models for analyzing transactions including a first model and a second model;
receiving a plurality of authorization data associated with a user and a transaction associated with the user;
executing in real-time the first model using the plurality of authorization data to receive a first output for the first model, wherein the first output is within an output range;
determining a remainder for the first model based on the first output and the output range;
executing the second model using the plurality of authorization data and the remainder to generate a second output;
combining the first output and the second output to generate a final output; and
returning in real-time the final output for decisioning on whether to authorize the trasnaction.

12. The method of claim 11, wherein the plurality of authorization data is received in an authorization request message, and wherein the plurality of authorization data includes authentication data collected from a user computing device during an online interaction over a computer network.

13. The method of claim 11, wherein the second output includes a score within the range based on the remainder, and wherein the final output includes a final score within the range.

14. The method of claim 11 further comprising:
determining a second remainder based on the first output, the second output, and the output range:
executing a third model of the plurality of models using the plurality of authorization data and the second remainder to generate a third output; and
combining the first output, the second output, and the third output to generate the final output.

15. The method of claim 11 further comprising determining whether to authorize the transaction initiated by the user based in part on the final output.

16. The method of claim 11, wherein the final output includes a final score that is based on the first output and the second output, wherein the second output is a residual-based model, and wherein the final score represents a likelihood of fraud associated with the transaction, and wherein the method further comprises declining the transaction if the final score meets a threshold level.

17. The method of claim 16 further comprising causing a step-up challenge to be displayed to the user via a user computer device if the final score meets another threshold level.

18. At least one non-transitory computer-readable medium comprising instructions stored thereon for authorizing an online user, the instructions executable by at least one processor to cause the at least one processor programmed to perform steps including:
store a plurality of models for analyzing transactions including a first model and a second model;
receive a plurality of authorization data associated with a user and a transaction associated with the user;
execute the first model using the plurality of authorization data to receive a first output for the first model, wherein the first output is based on an output range;
determine a remainder for the first model based on the first output and the output range;
execute the second model using the plurality of authorization data and the remainder to generate a second output;
combine the first output and the second output to generate a final output; and
return in real-time the final output for decisioning on whether to authorize the transaction.

19. The at least one non-transitory computer-readable medium according to claim 18, wherein the second output is within the output range based on the remainder, and wherein the final output is within the output range.

20. The at least one non-transitory computer-readable medium according to claim 18, the instructions executable by at least one processor to cause the at least one processor programmed to perform steps including present a step-up challenge to the user via a user computer device based on the final output.
